(19) United States
(12) Patent Application Publication
(10) Pub. No.: US 2014/0324240 A1
(43) Pub. Date: Oct. 30, 2014

(54) Method And System For Disaggregating Thermostatically Controlled Appliance Energy Usage From Other Energy Usage

(71) Applicant: Alcatel-Lucent USA Inc., Murray Hill, NJ (US)

(72) Inventors: Marina K. Thottan, Westfield, NJ (US); Dayu Huang, Schenectady, NY (US); Frank E. Feather, Englishtown, NJ (US)

(73) Assignee: Alcatel-Lucent USA Inc., Murray Hill, NJ (US)

(21) Appl. No.: 14/068,713

(22) Filed: Oct. 31, 2013

Related U.S. Application Data
(60) Provisional application No. 61/737,732, filed on Dec. 14, 2012.

(51) Int. Cl. G06Q 50/06; G05B 13/04

(52) U.S. Cl. CPC G06Q 50/06; G05B 13/04
USPC 700/291

(57) ABSTRACT

An apparatus includes processor and a memory communicatively connected to the processor. The processor is configured to receive total energy usage information that is related to a thermostatically controlled appliance and receive ambient temperature information related to the thermostatically controlled appliance. The processor derives a physical model for the thermostatically controlled appliance and other than the thermostatically controlled appliance, the physical model dependent on ambient temperature. The processor solves a Hidden Markov Model based on the total energy usage information and the physical model to obtain an energy usage model for the thermostatically controlled appliance and other than the thermostatically controlled appliance. Based on the total energy usage information, ambient temperature information, and the energy usage model, the processor determines energy use by the thermostatically controlled appliance.

### PRIORITY

The present application claims the benefit of U.S. Application Ser. No. 61/737,732, filed Dec. 14, 2012, which application is incorporated herein, in its entirety, by reference.

### TECHNICAL FIELD

The disclosure relates generally to energy use and, more specifically but not exclusively, to determining energy use associated with a thermostatically controlled appliance.

### BACKGROUND

The first step towards smart grid deployment is the installation of smart meters (i.e., sensors) at consumer premise. Smart meters provide detailed data on an individual household's electricity usage. Instead of monthly usage data collected via manual reading, it is now possible to collect usage measurements at specified time intervals, for example at five to fifteen (5-15) minute intervals. To realize the envisioned benefits of smart grid, such as energy savings, increased reliability, reduced cost and improved customer satisfaction, the collected data needs to be converted into actionable information for both the consumer and the utility energy provider. The benefit to the end consumer is a crucial element for the wide scale adoption of smart meters.

### SUMMARY OF EMBODIMENTS

Smart Meters have made it possible to have high-frequency measurement (e.g., on the order of minutes as opposed to monthly) of electricity usage for individual households. Given this, it is desirable to use smart meter measurement data to cost effectively design consumer energy services such as energy audit and demand response targeted towards improving an individual thermostatically controlled appliance's (e.g., a household's heating, ventilation and cooling (HVAC)) usage efficiency. However, to do this, the appliance's usage (e.g., HVAC usage of a household) must be estimated by disaggregating the appliance's usage from the total measurable usage (e.g., total household energy usage).

Embodiments herein provide a machine learning approach akin to Non-Intrusive Load Monitoring (NILM) to estimate the HVAC usage from a household's smart meter measurements and hourly outdoor temperature, without requiring a manual set-up procedure at each house. Once a household HVAC usage is found, that house can then be compared to similar houses to determine if it is a candidate for energy audit or demand response participation.

Embodiments of the methodology use a Hidden Markov Model (HMM) to capture the dependence of heating usage on outdoor temperature. Compared to the existing method based on linear regression, the proposed method is more accurate and provides better details on HVAC usage patterns.

This technique can be applied to disaggregate the usage of any appliance whose usage (1) exhibits the on-off usage behavior, and (2) has a dependence on other non-on-off usage data, e.g., temperature, time of day, day of week, TV program schedule, etc., or measurable data other than electric usage. Some examples of other appliances are multi-zone HVAC systems, pool pumps, washers, refrigerators, and entertainment systems.

In one example embodiment, an apparatus includes a processor and a memory communicatively connected to the processor. The processor is configured to receive total energy usage information that is related to a thermostatically controlled appliance, receive ambient temperature information related to the thermostatically controlled appliance, derive a physical model for the thermostatically controlled appliance and other than the thermostatically controlled appliance, the physical model dependent on ambient temperature, solve a Hidden Markov Model based on the total energy usage information and the physical model to obtain an energy usage model for the thermostatically controlled appliance and other than the thermostatically controlled appliance, and, based on the total energy usage information, ambient temperature information and the energy usage model, determine energy use by the thermostatically controlled appliance.

In one embodiment, the thermostatically controlled appliance is a heating unit, a ventilation unit, an air conditioning unit, a combination of one or more of a heating, ventilation, and air conditioning units, a HVAC unit, a pool pump, a washing machine, a refrigerator, or any appliance that exhibits an on/off behavior cycle.

In one embodiment, the processor is configured to determine whether electric power is used to supply the thermostatically controlled appliance based on whether the energy use of the thermostatically controlled appliance is approximately unchanged with changes in ambient temperature.

In one embodiment, the processor is configured to determine whether electric power is used to supply the thermostatically controlled appliance.

In one embodiment, the thermostatically controlled appliance is a device that exhibits on-off usage behavior and has a dependence on non-on-off usage data.

In one embodiment, the non-on-off usage data is at least one of temperature, time of day, day of week, day of year, TV program viewing schedule, or measurable data other than electric usage. The non-on-off usage data can indicate an on/off state change in the thermostatically controlled appliance.

In one embodiment, the physical model for the thermostatically controlled appliance is based on recorded specifications for a first thermostatically controlled appliance.

In one embodiment, the physical model for the other than the thermostatically controlled appliance is a Gaussian Mixture model.

In one embodiment, the processor is configured to, based on the energy use by the thermostatically controlled appliance, provide an information concerning an energy audit, provide a demand response offer, or provide a demand response offer for control of a setting of the thermostatically controlled appliance.

In one embodiment, the setting of the thermostatically controlled appliance is at least one of a temperature setting, a thermostatic set point, or a limit of a deadband.

In one embodiment, observed parameters of the Hidden Markov model include ambient temperature and change in total energy usage.

In one embodiment, non-observed parameters of the Hidden Markov model include change of energy usage of the thermostatically controlled appliance and change of energy usage of the other than the thermostatically controlled appliance.

In one embodiment, hidden states of the Hidden Markov model include indoor temperature and on-off state of the thermostatically controlled appliance at a discrete time.

In one embodiment, an apparatus includes a processor and a memory communicatively connected to the processor, with the processor configured to receive total energy usage information that is related to a first electric appliance that exhibits on/off behavior and that is dependent on an external factor, receive information related to the external factor for the first electric appliance, derive a physical model for the first electric appliance and other than the first electric appliance, the physical model dependent on the external factor, solve a Hidden Markov Model based on the total energy usage information and the physical model to obtain an energy usage model for the first electric appliance and other than the first electric appliance, and, based on the total energy usage information, the information related to the external factor and the energy usage model, determine energy use by the first electric appliance.

In one embodiment, the first electric appliance is a heating unit, a ventilation unit, an air conditioning unit, a combination of one or more of a heating, ventilation, and air conditioning units, a HVAC unit, a pool pump, a refrigerator, a washing machine, or an entertainment system.

In one embodiment, the processor is configured to, based on the energy use by the first electric appliance, provide an information concerning an energy audit, provide a demand response offer, or provide a demand response offer for control of a setting of the first electric appliance.

In one embodiment, observed parameters of the Hidden Markov Model include the external factor and change in total energy usage and non-observed parameters of the Hidden Markov Model include change of energy usage of the first electric appliance and change of energy usage of the other than the first electric appliance.

In one embodiment, hidden states of the Hidden Markov Model include indoor temperature and on-off state of the first electric appliance at a discrete time.

In one embodiment, a computer readable storage medium excluding signal and storing instructions which, when executed by a computer, cause the computer to perform a method. The method comprises receiving total energy usage information that is related to a first electric appliance that exhibits on/off behavior and that is dependent on an external factor, receiving information related to the external factor for the first electric appliance, deriving a physical model for the first electric appliance and other than the first electric appliance, the physical model dependent on the external factor, solving a Hidden Markov Model based on the total energy usage information and the physical model to obtain an energy usage model for the first electric appliance and other than the first electric appliance, and, based on the total energy usage information, the information related to the external factor, and the energy usage model, determining energy use by the first electric appliance.

In one embodiment, a method includes receiving at a processor total energy usage information that is related to a first electric appliance that exhibits on/off behavior and that is dependent on an external factor, receiving at the processor information related to the external factor for the first electric appliance, deriving at the processor a physical model for the first electric appliance and other than the first electric appliance, the physical model dependent on the external factor, solving at the processor a Hidden Markov Model based on the total energy usage information and the physical model to obtain an energy usage model for the first electric appliance and other than the first electric appliance, and, based on the total energy usage information, the information related to the external factor, and the energy usage model, determining at the processor energy use by the first electric appliance.

### BRIEF DESCRIPTION OF THE DRAWINGS

The teachings herein can be readily understood by considering the following detailed description in conjunction with the accompanying drawings, in which:

FIG. 1 shows an example system 100 for disaggregating climate control energy use from non-climate control energy, in accordance with one embodiment of the invention;

FIG. 2 depicts a high-level block diagram of a computer suitable for use in performing functions described herein;

FIG. 3 depicts an example HMM used for the disaggregation algorithm according to one or more embodiments of the invention;

FIG. 4 depicts an exemplary method for disaggregating electric usage according to the principles of the invention;

FIG. 5 illustrates the probability of detection error using HMM and linear regression methods using an experimental data set; and

FIG. 6 shows estimation errors for HMM and linear regression methods using the experimental data set.

To facilitate understanding, identical reference numerals have been used, where possible, to designate identical elements that are common to the figures.

### DETAILED DESCRIPTION OF EMBODIMENTS

Heating and cooling usage is a significant component of the energy consumption for a residential consumer (twenty-eight percent (28%) of annual usage in U.S. in 2010 and projected to increase worldwide). This usage is a promising avenue for implementing energy services that optimize the usage and provide benefits to the consumer. However, a challenge in designing these energy services is to extract the heating and cooling usage from the aggregated meter data without compromising the privacy of the consumer.

Presented herein are example methodologies and apparatuses for extracting heating usage information from aggregate meter readings in order to design customized residential energy services that optimize heating usage. The examples provided apply to thermostatically controlled heating appliances, however, they can be extended to cooling usage. Optimizing heating usage holds a significant potential for conserving energy and reducing peak usage. For example, an energy audit can improve the thermal efficiency of the building and thus reduce usage. Similarly, demand response programs for the grid can reduce peak usage by temperately adjusting the cycle of the heating appliance without significantly reducing the comfort level. Data analytics plays a role to support these energy audit and demand response services by customizing the services to the individual household usage patterns. For example, the estimated heating usage of a household could be compared to other similar households. If the usage is significantly higher than average, a recommendation for energy audit can be made to the house owner. In another example, the estimated heating usage characteristics are used to calculate its demand response potential. Such information can be used by the utility in implementing a residential demand response program.

These customized energy services may utilize the estimate of a household's heating usage, which may include not only the average daily energy consumed for heating, but also other characteristics, such as the number of on/off cycles of the heating appliances. The latter is important for estimating a house's potential contribution to a demand response program. Typically, the measurement of usage is done at a household level, rather than for individual appliances. This raises a technical problem addressed herein: estimating the heating usage from the aggregate usage data of a household. One or more embodiments provided herein address this problem by using Thermostatically Controlled Load (TCL) models to develop a Hidden Markov Model (HMM) for heating usage estimation. Exemplary input to this HMM may include: hourly (or sub-hourly) outdoor temperature readings and periodic (e.g., 15-minute) aggregate meter readings for the household.

A general goal of Residential Energy Services, or Home Energy Management Services (HEMS), is to save energy at home. There are numerous players in the Residential Energy Services market, including utility companies, government, standards groups, and manufacturers of infrastructure equipment such as the smart meters, thermostats and appliances. The most basic form of Home Energy Management is a home energy audit, which has someone come to the home and catalog and assess its energy efficiency, including the type of heating and cooling appliances, ratings of insulation, window types, and other demographics of the home. These audits are very extensive and therefore expensive. Most other HEMS are centered on the smart meter. Some HEMS are stand-alone solutions that target the consumer directly: the customer uses a smart thermostat and smart appliances that integrate with smart meters to monitor usage, learn a customer's habits, and then control the thermostat in order to optimize heating and cooling usage. Other HEMS are utility-centric, in that the utility company will use a smart meter infrastructure to monitor individual customer's usage and intelligently present the information and/or provide recommendations. These obviously require equipping a customer house with smart thermostat and appliances. However, a majority of these solutions simply monitor a customer's smart meter and present current and historical usage, along with trend lines and future usage prediction. There are a few companies that have sophisticated analysis to compare a customer's usage to that of his “neighbors”, where a neighbor has similar demographics, such as home size. Some other solutions disaggregate heating and cooling usage using regression analysis.

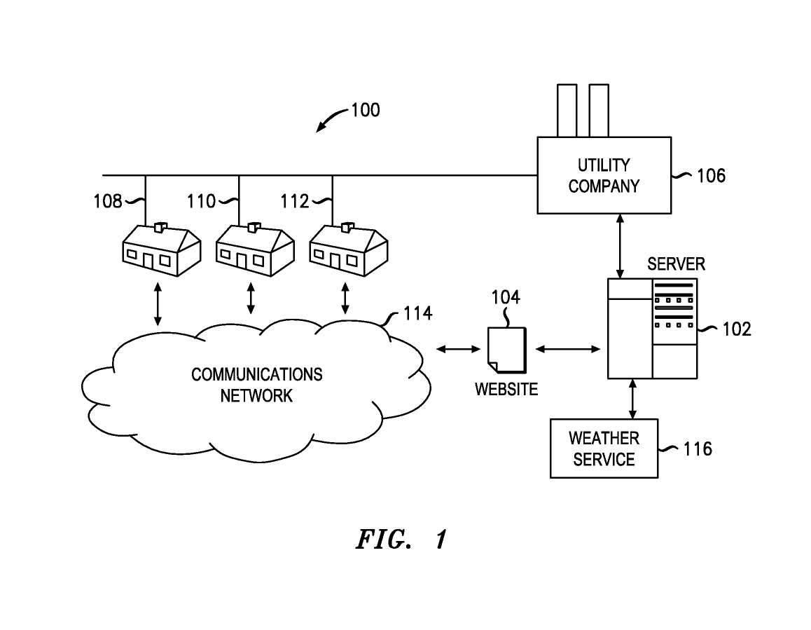

FIG. 1 shows an example system 100 for disaggregating climate control energy use from non-climate control energy, in accordance with one embodiment of the invention.

The system 100 includes a server 102 that, in some embodiments, supports a website 104. The server is in communication with a utility company 106. The utility company 106 provides electricity or gas to a plurality of buildings 108, 110, and 112. The utility company 106 tracks each building's energy use with a metering system. These building energy use values are received by the server 102 from the utility company 106. The building energy use values can be received by the server 102 via a communications network 114 (e.g., internet) as, for example, e-mails, downloaded FTP files, XML feeds, or metering feeds. However, in other embodiments, the global communications network is not used. Instead, the energy use values are sent by, for example, regular mail.

The server 102 is also in communication with a weather service 116, such as the National Weather Service. The server 102 receives corresponding outdoor temperatures from the weather service 116 via the communications network 114 (e.g., e-mails, downloaded FTP files, and XML feeds). However, in other embodiments, the corresponding outdoor temperatures may be received by regular mail. The server 102 then matches the building energy use values to the corresponding outdoor temperatures. For example, if one of the buildings is a household located in Portland, Me., then the server 102 will receive daily outdoor temperatures for Portland, Me. and match those outdoor temperatures to the household energy use values.

Using building energy use values and their corresponding outdoor temperatures, the server 102 calculates the climate control energy use and non-climate control energy use for each of the plurality of buildings 108, 110, and 112. The server 102 then communicates the energy use values to customers associated with those buildings 108, 110, and 112. In one or more embodiments of the invention, the server 102 communicates the energy use values via the communications network 114. For example, the server 102 may send the energy use values in an e-mail or, in another embodiment, the customer may log into the server supported website 104 and view his disaggregated climate control energy. In additional or alternative embodiments, the server 102 itself prints the energy use data or provides the information to a printing system so that the data can be provided to the customer via regular mail (e.g., as part of a utility bill). In other embodiments, the energy use data is communicated back to the utility company 106 so that the utility company can provide the data to the customer.

In exemplary embodiments of the invention, the server 102 includes a processor that may be programmed with any one or more of the following software modules:

A utility communication module for receiving energy use data.

A weather communication module for receiving corresponding outdoor temperature data.

A matching module for matching energy use data to corresponding outdoor temperatures.

A subtraction module for determining a series of temperature difference values.

A disaggregation module for calculating climate control energy use data and non-climate control energy use data.

A storage module for storing customer and building information (e.g., cooling coefficient, heating coefficient, non-climate control coefficient, energy use data, square feet, number of bedrooms, e-mail, and address).

A website module for supporting the website.

A customer communication module for communicating climate control energy use data and non-climate control energy use data to the customers via, for example, the website or e-mail.

A printing module for printing climate control energy use data and non-climate control energy use data to be sent to customers via regular mail.

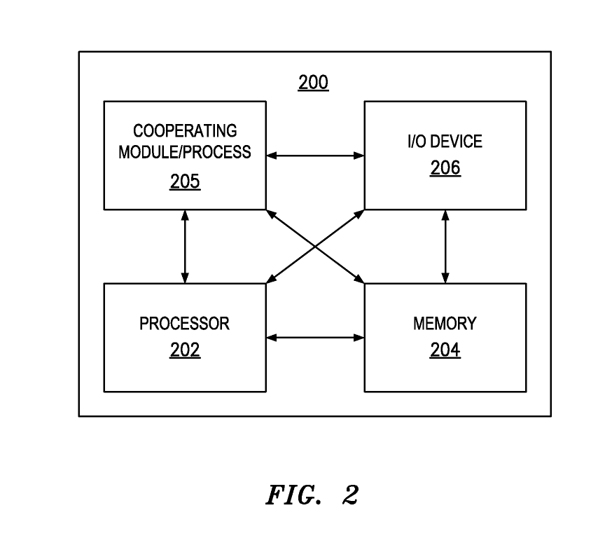

FIG. 2 depicts a high-level block diagram of a computer suitable for use in performing functions described herein.

The computer 200 includes a processor 202 (e.g., a central processing unit (CPU) or other suitable processor(s)) and a memory 204 (e.g., random access memory (RAM), read only memory (ROM), and the like).

The computer 200 also may include a cooperating module/process 205. The cooperating process 205 can be loaded into memory 204 and executed by the processor 202 to implement functions as discussed herein and, thus, cooperating process 205 (including associated data structures) can be stored on a computer readable storage medium, e.g., RAM memory, magnetic or optical drive or diskette, and the like.

The computer 200 also may include one or more input/output devices 206 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 200 depicted in FIG. 2 provides a general architecture and functionality suitable for implementing functional elements described herein or portions of functional elements described herein. For example, the computer 200 provides a general architecture and functionality suitable for implementing one or more of server 102, smartmeter 108, 110, 112, one or more elements of communications network 114, weather service 116, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or,” unless otherwise indicated (e.g., “or else” or “or in the alternative”).

It should be noted that terms such as “processor” and “server” may be used herein to describe devices that may be used in certain embodiments of the invention and should not be construed to limit the invention to any particular device type or system unless the context otherwise requires. Thus, a system may include, without limitation, a client, server, computer, appliance, or other type of device. Such devices typically include one or more network interfaces for communicating over a communication network and a processor (e.g., a microprocessor with memory and other peripherals and/or application-specific hardware) configured accordingly to perform device and/or system functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies, networking technologies, and internetworking technologies.

It should also be noted that devices may use communication protocols and messages (e.g., messages created, transmitted, received, stored, and/or processed by the system), and such messages may be conveyed by a communication network or medium. Unless the context otherwise requires, the invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the invention to any particular logic flow or logic implementation. The described logic may be partitioned into different logic blocks (e.g., programs, modules, interfaces, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the invention, predominantly all of the described logic is implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

As described above, there are several approaches to estimating HVAC usage including home energy audits and smart meter solutions, such as HEMS stand-alone solutions and HEMS utility-centric solutions. These approaches may include disaggregating HVAC usage from meter data using regression analysis. However, regression analysis is not as effective as the inventive methodologies provided herein.

Other disaggregation work requires: (1) high sampling frequency (<1 s [1 Hz]); and (2) appliance information, such as historical usage of individual appliances to distinguish between the usage of different appliances using the real and reactive power consumed at the steady state as the signature of individual appliances. In contrast, the inventive methodologies provide herein do not need any of these required conditions (i.e., (1) and (2) above) to perform Non-Intrusive Load Monitoring (NILM). According to one or more embodiments of the invention, the sampling interval utilized may be one the order of minutes (e.g., 5-15 minutes), which is typical for most smart meters. The provided methods also work without historical data of HVAC appliance usage at individual houses, or appliance details. This is an advantage, since it is not desirable to ask consumers to undertake an intrusive manual data collection procedure. In addition, the provided methodologies are expandable to use meter data to disaggregate usage of any appliance the exhibits an on/off cycle, such as pool pumps, washers, entertainment systems, multi-zone HVAC, etc.

The provided methodologies disaggregate individual appliance usage from overall usage on an individual household by utilizing smart meter measurements (e.g., available at 5-15 minute intervals) and other measurable quantities such as weather data or a diary of residents' activities. The provided methodologies use a Hidden Markov Model (HMM) to find this dependence of appliance usage on the other quantities or external factor/s. For the HVAC case, the provided methodologies rely on the on/off properties of an HVAC appliance, and its dependence on outside temperature.

The provided methodologies are applicable to disaggregate usage of any household appliance that exhibits an on/off usage cycle, and has dependence on other quantities. Some examples include multi zone HVAC, pool pumps, washers, stoves, and entertainment systems to name a few.

Provided methodologies enable disaggregation of energy consumption of the heating appliance from total usage for a house, focusing on estimating the usage of heating appliance with on/off states controlled by a thermostat, which is the focus of residential demand response programs.

Let y(t) denote the aggregate real power consumption of a house at time t, and w(t) denote the power consumption of the heating appliance. Consider meter measurements taken at sampling interval of length Δ. Denote the aggregate energy and the energy consumed by the heating appliance at the kth interval by

y[k]=∫_{(k-1)Δ}^{kΔ}y(t)dt and w[k]=∫_{(k-1)Δ}^{kΔ}w(t)dt. Let θ₀[k] be the outdoor temperature at time kΔ.

In the disaggregation problem, the inputs given to the algorithm are the sequences {y[k]} and {θ[k]}, and the required output is a sequence of estimates {ŵ[k]} of the true heating usage {w[k]}, or estimates of other functionals of w(t). For the energy audit and demand response services, the relevant estimates are: (1) The average heating power over time

$$T \text{:} \frac{1}{T} {\int }_{0}^{T} w ( t ) d t ;$$

and (2) The average energy consumed during each on/off period:

$$\frac{1}{N ( T )} {\int }_{0}^{T} w ( t ) d t ,$$

where N(T) is the number of times that the appliance is on during [0,T].

Assumptions taken in proposed embodiment according to the principles of the invention include:
1. The household of interest has one single thermostatically controlled heating appliance that switches between an on and an off state. The heating appliance is turned on when the indoor temperature is lower than a preset temperature and turned off when it is higher than another preset temperature.
2. The sampling frequency 1/Δ is higher than the frequency that the heating appliance switches between on and off states.
3. The heating appliance consumes the same amount of energy during each period that it is on.
   The last assumption is only an approximation: The time that a thermostatically controlled heating appliance stays on and its power consumption depends on the outdoor temperature. One possible way to relax this assumption is to explicitly model this temperature dependence.

### Non-Intrusive Load Monitoring

Disaggregating individual appliance usage from the aggregate usage of a house is called Non-Intrusive Load Monitoring (NILM). The main varying characteristics of NILM methods are: (1) the sampling interval Δ (or sampling frequency); (2) the appliance information needed, such as historical usage of individual appliances; (3) the types of appliance whose usage the method disaggregates. The sampling frequency and appliance information are limited by the data collection procedure.

According to one NILM method, the real and reactive power are used as signatures of individual appliances. Such a NILM method first detects the change of aggregate instantaneous power consumption which signifies the on/off state change of an appliance, and then matches how much the power consumption changes to the appliance signatures. An exemplary sampling interval for such a NILM method is Δ=1 s. When the sampling interval increases, the probability that two or more appliances change their power consumption at the same interval increases. For smart meter measurements of energy consumption collected at 15 minutes or less frequently, machine learning methods, such as a rule-based algorithm and neural-networks may be used. These machine learning methods disaggregate the usage of large appliances, such as HVAC, water heaters and pool pumps, by treating the usage of smaller appliances as noise. Other signatures such as the voltage spectrum or transients, which are available from higher frequency measurements, may also be used but are not available with measurements having 15-minute intervals.

### Linear Regression

A method based on linear regression may be used to disaggregate heating usage from total usage measured at 15-minute or 1-hour intervals. The difference between the outside temperature, θ₀[k], and a predetermined baseline temperature, θ_{B}, is defined as:

d[k]=max{θ_{B}−θ₀[k],0}.

For example, a possible choice of θ_{B} is 18.3° C. Then y[k] is regressed against d[k] to obtain estimates of βₒ, β₁:

y[k]=βₒ+β₁d[k].

The estimated heating usage is then given by ŵ[k]=\hat{β}₁d[k], where \hat{β}₁ is the estimate of β₁. The key assumption in a linear regression based method is that the usage of non-heating appliances is a constant. The linear regression method neglects the on/off behavior of appliances, and is suitable for estimating average heating power.

### One or More Embodiments

One or more embodiments described herein build upon existing methods in NILM. According to one embodiment, one way to disaggregate heating usage is to apply methods described in the paragraphs under the Non-Intrusive Load Monitoring section above and then identify which appliance is a heating appliance. One or more embodiments provided herein use the temperature dependence of heating appliance usage directly in the NILM method to help disaggregate heating usage: It uses the change of energy consumption as well as its dependence on the temperature as the appliance signatures.

One or more embodiments provided herein use HMMs to model energy usage. HMMs are stochastic models that have the ability to capture complex dependences between variables.

There are two types of variables in an HMM: observed variables and hidden variables where the sequence of hidden variables forms a Markov process. In previous NILM methods, the hidden variables are used to model the on/off state of individual appliances. The observed variables are conditionally independent of each other given the value of the hidden variables, and they are used to model the electric usage. In the proposed method, the hidden variable models the on/off state as well as the indoor temperature seen at the thermostat, and the evolution of the hidden variables depends on the outdoor temperature. This allows the capture of the temperature dependence of the electricity usage.

One advantage of using an HMM is its flexibility: Additional variables can be added to the HMM. For example, if there is a survey on electric heating appliances in the utility's area, then a variable can be added to incorporate this piece of information.

First described below is the Thermostatically Controlled Load (TCL) model for HVAC, which is then used to derive the Hidden Markov Model (HMM) for heating usage disaggregation.

### TCL Model

The following TCL model and its discrete time version have been used to describe the evolution of the temperature seen at the thermostat θ(t):

$$\frac{d }{d t} θ ( t ) = - \frac{1}{τ} ( θ ( t ) - {θ}_{f} ( t ) - μ ( t ) {θ}_{g} )$$

where θ_{f}(t) is the target temperature that θ(t) approaches when the heating appliance is off, and θ_{g} is the additional heat gain when it is on. The binary-valued u(t) is the on/off state of the heating appliance: u(t)=1 when it is on, and u(t)=0 when it is off. The on/off state is determined by how θ(t) compares to lower and upper set-points of the thermostat θₗ and θᵤ: u(t) does not change if θₗ<(t_)<θᵤ; u(t)=1 if θ(t_)≦θₗ, and u(t)=0 if θ(t_)≧θᵤ.

This TCL model is the basis for the HMM used in the disaggregation algorithm. The thermal dynamics of a house is more complicated than Equation (1). Simulating a house's heating requires detailed models with a large number of variables and parameters. The provided approach is not to fit a simulation model to the usage data. The heating usage is inferred from the usage data directly and the TCL model is used to distinguish the heating usage from other usages that do not depend on temperature. In statistical inference, it is well-known that a simpler model is preferred when only limited amount of data is available.

### HMM

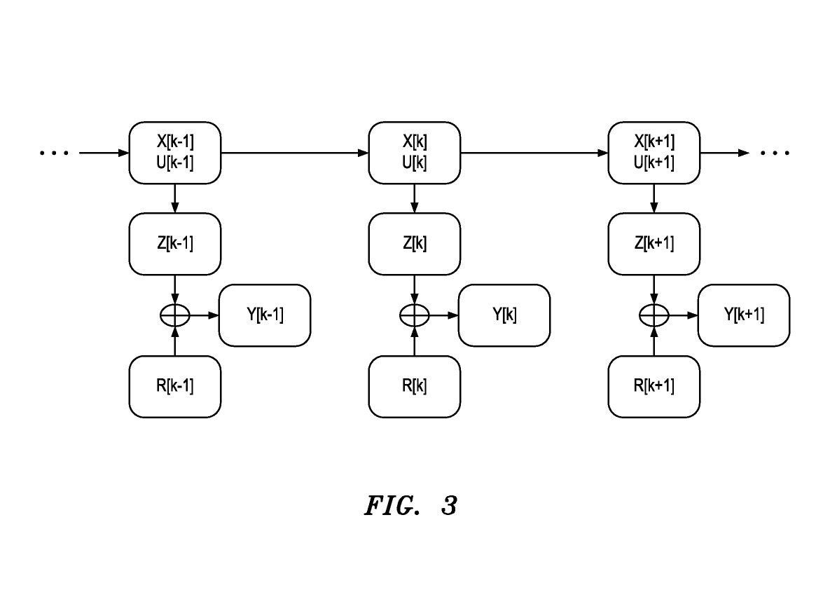

FIG. 3 depicts an example HMM used for the disaggregation algorithm according to one or more embodiments of the invention. The HMM will take as input aggregate measurement data (e.g., total energy usage) and measurements from an external stimulus (e.g., non-on-off usage) that can cause a state change of the appliance which exhibits an on/off usage behavior. In the HMM used for the disaggregation depicted in FIG. 3, the sequences {z[k]} and {r[k]} model the usage of heating and non-heating appliances, respectively. The total usage y[k] is given by y[k]=z[k]+r[k]. Rather than using z[k] and r[k] directly as the variables of HMM, we use the difference between two consecutive values: Define Z[k]=z[k]−z[k−1], R[k]=r[k]−r[k−1], Y[k]=y[k]−y[k−1]. The observed variable of the HMM is Y[k]=Z[k]+R[k].

The change of non-heating usage {R[k]} is modeled as an i.i.d. sequence of symmetric Gaussian mixture random variables with s₀+2s₁ components, where the s₀ components model the change of aggregate usage of small appliances and s₁ components model that of large appliances. The density function is given by

$${f}_{R \vert k ]} ( r ) = {\sum }_{v = 1}^{{s}_{o} + 2 {s}_{1}} {α}_{v} \frac{1}{\sqrt{2 {πσ}_{v}^{2}}} exp \{ - \frac{{( r - {μ}_{v} )}^{2}}{2 {σ}_{v}^{2}} \} ,$$

where the coefficients {αᵥ} satisfying Σᵥ₌₁^{s}^{₀}^{+2s}^{₁} αᵥ=1 are the probabilities of individual Gaussian components. The parameters uᵥ and σᵥ are the mean and variance of the vth component. The following constraints are imposed so that the resulting density function is symmetric: uᵥ=0 for 1≦i≦s₀, uₛₒ₊₂ᵢ₋₁=−uₛₒ₊₂ᵢ and σₛ_{ₒ}₊₂ᵢ₋₁²=σₛ_{₀}₊₂ᵢ² for 1≦i≦s₁.

The modeling of heating usage is now described. The change of the heating usage Z[k] depends conditionally on the state variable pair (X[k], U[k]). The real-valued variable X[k] models the temperature seen at the thermostat at time kΔ. The two-dimensional vector U[k]ε{0,1}² models heating gain from the heating appliance at time interval k−1 and k. U[k]₁=0 and U[k]₂=1 indicates that the heating device is off during [(k−1)Δ, (k−2)Δ) and is on during [(k)Δ, (k−1)Δ). Note that the HMM has been extended to the case where U[k]ᵢ takes more than 2 values; with only the binary value being described here. The value of (X[k], U[k]) depends on the value of (X[k−1], U[k−1]) and θₒ[k]. The transition probability is given by:

$$Pr \{ {U [ k ]}_{2} = 1 \text{\textbar} X [ k - 1 ] = x \} = ( 1 - η ) χ \{ x \leq {T}_{l} \} + ηχ \{ x > {T}_{l} \} , \\ Pr \{ X [ k ] ∈ A \text{\textbar} X [ k - 1 ] = x , {U [ k ]}_{2} = u \}$$

$${\int }_{{x}^{′} ∈ A}^{ } \frac{1}{\sqrt{2 {πσ}_{X}^{2}}} exp \{ - \frac{{{x}^{′} - [ λ x + ( 1 - λ ) {θ}_{0} [ k ] + μ g ] )}^{2}}{2 {σ}_{X}^{2}} \} ,$$

where χ is the indicator function, η is close to 0.

The dependence between Z[k] and U[k] is given by

Z[k]=\hat{μ}(U[k]₂−U[k]₁+ε[k]

where ε[k] is a Gaussian random variable of mean 0 and variance σ_{Z}².

The parameters that appear in the HMM are divided into two groups: The first group includes Tₗ, λ, \hat{μ}, {αᵥ, μᵥ, σᵥ²}; The second group includes σ_{X}², σ_{Z}², g, η. The second group are the same for all houses, and given the availability of training data can be optimized to minimize the estimation error. The first group, on the other hand, varies with different houses and are estimated from the usage data.

The disaggregation algorithm computes the maximum-likelihood estimates of Tₗ, λ, \hat{μ}, {αᵥ, μᵥ, σᵥ²}; and {U[k]}. The estimate of heating usage is given by ŵ[k]=\hat{μ}U[k]₂.

The maximum-likelihood estimation of λ, \hat{μ}, {αᵥ, μᵥ, σᵥ²} and U[k] uses the well-known Baum-Welch algorithm, (e.g., the standard procedure of the Baum-Welch algorithm) which is guaranteed to converge to a local optimum. The same estimation procedure is repeated with different choices of Tₗ and the one yielding the maximum likelihood value is used.

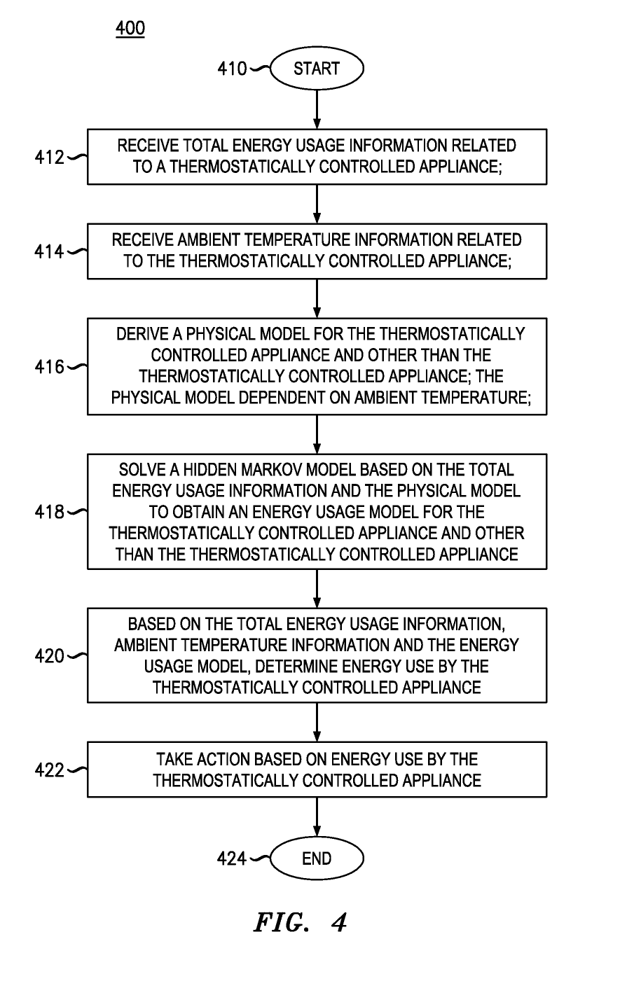

FIG. 4 depicts an exemplary method for disaggregating electric usage according to the principles of the invention. Referring to FIG. 4, the method starts at operation 410. At operation 412 total energy usage information that is related to a thermostatically controlled appliance is received. At operation 414, ambient temperature information related to the thermostatically controlled appliance is received. At operation 416 a physical model for the thermostatically controlled appliance and other than the thermostatically controlled appliance is derived. The physical model is dependent on ambient temperature. At operation 418, a Hidden Markov Model based on the total energy usage information and the physical model is solved to obtain an energy usage model for the thermostatically controlled appliance and other than the thermostatically controlled appliance. At operation 420, based on the total energy usage information, ambient temperature information and the energy usage model, energy use by the thermostatically controlled appliance is determined. At operation 422, an action is taken based on the energy use by the thermostatically controlled appliance. The action may take the form of providing an information concerning an energy audit, providing a demand response offer, or providing a demand response offer for control of a setting of the thermostatically controlled appliance. At operation 424, the method ends.

The proposed disaggregation methodology may be applied toward problems including: detection of the existence of electric heating and estimation of heating usage per household.

For example, two data sets were used in an experiment concerning the detection of the existence of electric heating. The first data set was real-world data. The real-world data included two weeks of electricity usage of 76 houses in winter, measured at 15-minutes sampling interval, hourly temperature measurements at a weather station, and a survey filled out by the consumer that describes what type of heating appliance is used. The survey data was converted to a binary label indicating whether the house has electric or non-electric heating. Among the 76 houses, 47 of them were labeled as having electric heating. Hourly temperature was interpolated to obtain out-door temperature at 15-minutes interval.

The second data set was synthetic, created for the estimation problem to evaluate the accuracy of the heating usage disaggregation, since the real-world data set does not include the ground truth of heating usage. The synthetic data included the usage of 100 virtual houses generated as follows: The electric heating usage of a virtual house is simulated using HAMbase-S software, and the non-heating usage of a virtual house is obtained by taking the real-world usage of houses with non-electric heating.

The simulation of electric heating usage used a known one-zone building model given, in which multiple difference equations were used to compute the thermal dynamics, and the thermal resistance of the walls were chosen so that the lumped thermal resistance was within a chosen range. The heating appliance had only on and off states controlled by a thermostat. Only one heating usage sequence was simulated and used for all the virtual houses.

The non-heating usage may was obtained from the real-world usage data from 100 real houses labeled as non-electric heating. These houses were evenly divided into two groups according to the size and value of the house and the year when it was built. One group included larger, newer and more expensive houses and another group included smaller, older and less expensive houses. The reason to consider multiple groups instead of one was based on the observation that on average larger houses have higher non-heating electricity usage than small houses.

Currently about a half of the houses in the Unites States built after 2000 are heated using electricity, and newer houses are more likely to have electric heating. The information whether a house uses electric heating is useful, for example, in HEMS in which a household's usage is compared against a selected group of other households to provide feedback on its consumption, since houses heated using electricity generally have higher electricity usage than others.

In this detection problem, the input is the total usage and temperature, and the output is whether the house has electric or non-electric heating. There are two types of errors: type I error in which a house without electrical heated is incorrectly detected as electric heating, and type II error in which a house with electric heating is detected as having no electric heating. The performance of a detection algorithm is characterized by the probabilities of these two errors:

Type I error probability=Number of Type I errors made/Number of houses with no electric hearing.

Type II error probability=Number of Type II errors made/Number of houses with electric hearing.

A threshold test is applied to the output of disaggregation algorithms: A house is detected as electrically heated if the estimated average heating power is larger than a threshold. The threshold dictates the trade-off between the two errors.

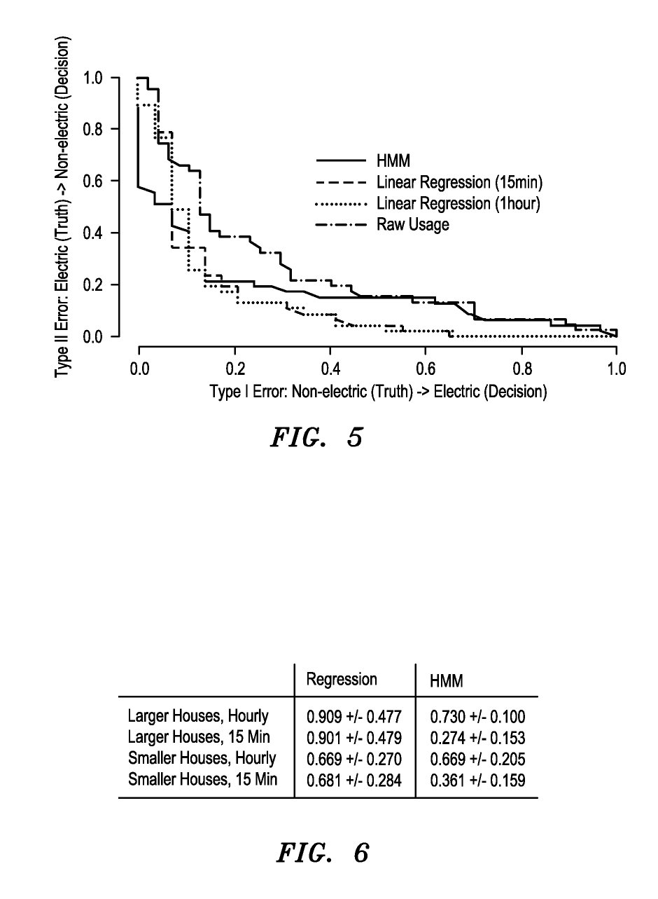

The error probabilities using HMM and linear regression methods, with varying thresholds, are depicted in FIG. 5. In FIG. 5 illustrates the probability of detection errors: HMM method with a 15-minute sampling interval (red and solid), linear regression with a 15-minute sampling interval (blue and dashed) or 1-hour sampling interval (green and dotted), threshold test on raw usage (purple and dash-dotted). θ_{B}=18.3° C. The threshold test was applied directly to the raw aggregate usage to obtain a baseline error. In FiG. 5, the extreme right is a low threshold, where every house is detected as having electric heating, while the extreme left is a high threshold where no houses are detected as electrically heated.

Three observations are made: First, detection using either disaggregation algorithm performs better than that using raw usage; Second, the probability of error for the linear regression method is almost the same for 15-minutes and 1-hour measurements; Third, the HMM method is worse than linear regression at one end of the curve and better at the other. So form a purely detection perspective, the linear regression method is favorable, considering its low computational complexity and less stringent requirement on the sampling frequency.

The best method and best threshold value also depends on the cost of a mis-diagnosis. For example, to classify a house as having electric heating when it actually is non-electric (Type I error), might result in a foolish recommendation that the house participate in a demand response program. Similarly, a missed detection (Type II error), i.e., the house is diagnosed as not having electric when it actually does, would result in a lost opportunity. In general, it is desirable to balance the two error types and choose a threshold somewhere in the middle, for example, where the curve is closest to the lower left corner of the graph.

The disaggregation algorithm estimates heating usage. Using synthetic data, the accuracy of the algorithm was evaluated by its estimation error, which is defined as:

$$Estimation error = \vert 1 - ( {\sum }_{k} \hat{w} [ k ] ) / ( {\sum }_{k} w [ k ] ) \vert$$

FIG. 6 shows estimation errors for HMM and linear regression methods. The results are the mean and 1 standard deviation, and are categorized by the type of house (larger/smaller houses), and the sampling interval (15-minutes/1-hour). As observed in FIG. 6, the HMM method had lower error, especially for tight sampling (15 minute).

Three observations are made: First, the estimation error of the HMM method increases with lower sampling frequency, while the linear regression method is insensitive to the sampling frequency. This occurs because the HMM method uses the difference Y[k]=y[k]−y[k−1] to infer the on/off event of the heating device and thus is affected by how the frequency of the on/off event compares to the sampling frequency. With 1-hour sampling, the second assumption of the HMM method is violated, and the usage in two or more consecutive on-periods sometimes is lumped together.

Second, the error of the linear regression method is larger for larger houses which have higher non-heating usage, compared to those of smaller houses. This is due to the linearity of the regression method. The error of the HMM method does not significantly depend on the amount of non-heating usage since the model explicitly accounts for this. Third, the HMM method with 15-minutes data is more accurate than linear regression.

One or more embodiments of the invention may use the heating usage disaggregation algorithm for demand response and energy audit services. For example, consider the demand response program in which the utility directly changes the on/off state of heating appliances to temporarily change the heating usage, and thus provides demand response to the grid. To maintain consumer's comfort level, the heating appliance only responds to the control signal if the indoor temperature is within the deadband [θₗ θᵤ] (e.g., θ_{B}=18.3° C.). Therefore, the potential contribution of a household to a demand response program depends on its heating usage characteristics.

The disaggregation algorithm described herein can be used to estimate individual households' potential contribution. The utility could then apply targeted advertisement or give higher incentives to those houses with high potentials to encourage them to participate in demand response.

One important metric of the demand response service is the power capacity over a required duration, i.e., the amount of power that the demand response service can provide consistently over this time interval. Contribution of each household to the power capacity is limited by both the average heating power as well as the average energy consumed during each on/off period. Assuming that the same amount of power capacity must be provided for both increasing and decreasing demand, we use the following formula to estimate the potential contribution of a house:

potential of a house=min{Average heating power,Average energy consumed in each period/Duration as a demand response resource}.

The required duration as a demand response resource is determined by the type of services it provides. The HMM-based disaggregation algorithm is applied to estimate the average energy consumed in an on-period and an average heating power, such as the average heating power for electrically heated houses. A house is recommended to participate in demand response Here we consider a duration of 2 hours for load following over a period of time if its estimated contribution is larger than a threshold.

Varying the threshold leads to different number of recommended houses, as well as different total power capacity and average power capacity contributed per house. If the cost of demand response program includes both fixed cost per customer and payments according to actual contributions, then both the total capacity and the average capacity per house should be considered in designing and optimizing the demand response program.

Disaggregation algorithms give the estimated heating usage for individual houses. This information can be used to provide feedback to consumers on how they compare to other similar households. Appropriate comparison group for a household may be based on the size or age of the house. Such groupings can be identified using public information. Thus, it is possible to provide consumers with information on the amount of savings they may get from an energy audit.

A variety of considerations may be review prior to deployment of an embodiment according to the principles of the invention. Deployment considerations include:

Data Availability: The disaggregation algorithm requires individual meter usage and outdoor temperature data. The performance of the HMM method depends on the sampling frequency. Therefore, it is important to find an optimal sampling frequency prior to deploying this method. The optimal sampling frequency depends on the typical on/off cycle of heating appliances, which can be estimated, for example, from a survey, or collecting and analyzing high-frequency usage data from a few representative homes.

Computation: The computational complexity of both the HMM and linear regression methods increases linearly with the number of data samples. The HMM method's computational complexity per data sample is much higher than that of linear regression, and depends on the number of iterations. However this is not a big concern for energy services where the disaggregation algorithm is applied off-line. Moreover, the rich literature on HMM can be leveraged to find approximate methods with smaller computational complexity.

Consumer Population: Consumer characteristics such as people migration, especially of those living in rented houses could lead to different usage patterns for the same meter. The learning for the disaggregation algorithm is specific to a particular consumer's usage pattern.

Provided herein are embodiments for utilizing an HMM-based algorithm to estimate individual household heating usage from aggregate smart meter data. These estimates can be used to design customized energy services that benefit the end consumer. Disaggregating appliance usage (especially HVAC) would be extremely useful to a utility for identifying outlier households that can be candidates for energy audit or participants in a demand response program.

For example, the provided embodiments would be very valuable to a power company, in particular, within the Home Energy Management System (HEMS) within a Smart Grid Management System (SGMS) for non-intrusively disaggregating a customer's HVAC usage. Once HVAC usage is separated, the HEMS can then more easily compare a customer's usage to similar customers (based on demographics), and determine if the customer's usage is higher than normal. This would be valuable information for a household: they could find ways to conserve energy, such as better insulation, intelligent thermostats, or simply change habits. This would also be valuable for the utility to identify candidates for a home energy audit, or participation in a demand response program.

In the latter case, disaggregating the usage of appliances, such as HVAC, water heater or pool pump, is very valuable to a power company, because by separating out appliance usage, the utility can identify best candidates for participation in the demand response program, thus optimizing the implementation of the program.

Even though linear regression based approaches can solve the detection problem, it is desirable to have sophisticated methods like HMM to delineate the usage patterns in an intelligent manner in order to create customized energy services for different consumer groups.

The embodiments of the invention described above are intended to be merely exemplary; numerous variations and modifications will be apparent to those skilled in the art. All such variations and modifications are intended to be within the scope of the invention. That is; other and further embodiments may be devised without departing from the basic scope thereof.

What is claimed is:

1. An apparatus, comprising:
a processor and a memory communicatively connected to the processor, the processor configured to:
receive total energy usage information that is related to a thermostatically controlled appliance;
receive ambient temperature information related to the thermostatically controlled appliance;
derive a physical model for the thermostatically controlled appliance and other than the thermostatically controlled appliance, the physical model dependent on ambient temperature;
solve a Hidden Markov Model based on the total energy usage information and the physical model to obtain an energy usage model for the thermostatically controlled appliance and other than the thermostatically controlled appliance; and
based on the total energy usage information, ambient temperature information, and the energy usage model, determine energy use by the thermostatically controlled appliance.

2. The apparatus of claim 1, wherein the thermostatically controlled appliance is a heating unit, a ventilation unit, an air conditioning unit, a combination of one or more of a heating, ventilation, and air conditioning units, a HVAC unit, a pool pump, a washing machine, a refrigerator, or an appliance that exhibits an on/off behavior cycle.

3. The apparatus of claim 2, wherein the processor is configured to
determine whether electric power is used to supply the thermostatically controlled appliance based on whether the energy use of the thermostatically controlled appliance is approximately unchanged with changes in ambient temperature.

4. The apparatus of claim 2, wherein the processor is configured to
determine whether electric power is used to supply the thermostatically controlled appliance.

5. The apparatus of claim 1, wherein the thermostatically controlled appliance is a device that exhibits on-off usage behavior and has a dependence on non-on-off usage data.

6. The apparatus of claim 5, wherein the non-on-off usage data is at least one of temperature, time of day, day of week, day of year, TV program viewing schedule, or measurable data other than electric usage.

7. The apparatus of claim 1, wherein the physical model for the thermostatically controlled appliance is based on recorded specifications for a first thermostatically controlled appliance.

8. The apparatus of claim 1, wherein the physical model for the other than the thermostatically controlled appliance is a Gaussian Mixture model.

9. The apparatus of claim 1, wherein the processor is configured to,
based on the energy use by the thermostatically controlled appliance,
provide an information concerning an energy audit,
provide a demand response offer, or
provide a demand response offer for control of a setting of the thermostatically controlled appliance.

10. The apparatus of claim 9, wherein the setting of the thermostatically controlled appliance is at least one of a temperature setting, a thermostatic set point, or a limit of a deadband.

11. The apparatus of claim 1, wherein observed parameters of the Hidden Markov model include ambient temperature and change in total energy usage.

12. The apparatus of claim 1, wherein non-observed parameters of the Hidden Markov model include change of energy usage of the thermostatically controlled appliance and change of energy usage of the other than the thermostatically controlled appliance.

13. The apparatus of claim 1, wherein hidden states of the Hidden Markov model include indoor temperature and on-off state of the thermostatically controlled appliance at a discrete time.

14. An apparatus, comprising:
a processor and a memory communicatively connected to the processor, the processor configured to:
receive total energy usage information that is related to a first electric appliance that exhibits on/off behavior and that is dependent on an external factor;
receive information related to the external factor for the first electric appliance;
derive a physical model for the first electric appliance and other than the first electric appliance, the physical model dependent on the external factor;
solve a Hidden Markov Model based on the total energy usage information and the physical model to obtain an energy usage model for the first electric appliance and other than the first electric appliance; and
based on the total energy usage information, the information related to the external factor, and the energy usage model, determine energy use by the first electric appliance.

15. The apparatus of claim 14, wherein the first electric appliance is a heating unit, a ventilation unit, an air conditioning unit, a combination of one or more of a heating, ventilation, and air conditioning units, a HVAC unit, a pool pump, a refrigerator, a washing machine, or an entertainment system.

16. The apparatus of claim 14, wherein the processor is configured to
based on the energy use by the first electric appliance,
provide an information concerning an energy audit,
provide a demand response offer, or
provide a demand response offer for control of a setting of the first electric appliance.

17. The apparatus of claim 14, wherein
observed parameters of the Hidden Markov Model include the external factor and change in total energy usage; and
non-observed parameters of the Hidden Markov Model include change of energy usage of the first electric appliance and change of energy usage of the other than the first electric appliance.

18. The apparatus of claim 14, wherein hidden states of the Hidden Markov Model include indoor temperature and on-off state of the first electric appliance at a discrete time.

19. A computer-readable storage medium excluding signals and storing instructions which, when executed by a computer, cause the computer to perform a method, the method comprising:
receiving total energy usage information that is related to a first electric appliance that exhibits on/off behavior and that is dependent on an external factor,
receiving information related to the external factor for the first electric appliance;
deriving a physical model for the first electric appliance and other than the first electric appliance, the physical model dependent on the external factor;
solving a Hidden Markov Model based on the total energy usage information and the physical model to obtain an energy usage model for the first electric appliance and other than the first electric appliance; and
based on the total energy usage information, the information related to the external factor and the energy usage model, determining energy use by the first electric appliance.

20. A method, comprising:
using a processor for:
receiving total energy usage information that is related to a first electric appliance that exhibits on/off behavior and that is dependent on an external factor,
receiving information related to the external factor for the first electric appliance;
deriving a physical model for the first electric appliance and other than the first electric appliance, the physical model dependent on the external factor;
solving a Hidden Markov Model based on the total energy usage information and the physical model to obtain an energy usage model for the first electric appliance and other than the first electric appliance; and
based on the total energy usage information, the information related to the external factor, and the energy usage model, determining energy use by the first electric appliance.
